(19) United States
(12) Patent Application Publication
(10) Pub. No.: US 2009/0154387 A1
(43) Pub. Date: Jun. 18, 2009

(54) DISTRIBUTING DIGITAL VIDEO CONTENT TO MOBILE TERMINALS USING PRIMARY AND SECONDARY COMMUNICATION NETWORKS

(75) Inventor: Terrence Edward Rogers, Chapel Hill, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/956,801

(22) Filed: Dec. 14, 2007

(51) Int. Cl. H04H 20/71

(52) U.S. Cl. 370/312

(57) ABSTRACT

A system for broadcasting digital information includes a digital video front end processor configured to process a digital video signal for broadcast by a digital video transmitter. The digital signal includes a plurality of sequential datagrams and the digital video front end processor may be configured to generate a digital transmission stream in response to the digital video signal and to modulate the digital transmission stream. The system further includes a first transmitter configured to receive the modulated digital transmission stream from the front end and to broadcast the modulated digital transmission stream over a first communication interface, and a second transmitter configured to receive the plurality of datagrams and to transmit selected ones of the plurality of datagrams to a receiving terminal over a second communication interface different from the first communication interface in response to a request from the receiving terminal.

### FIELD OF THE INVENTION

The present invention relates to communications systems and methods, and more particularly, to communications systems and methods for delivering digital video content to mobile terminals.

### BACKGROUND

Video programs, which may include audio content, video content and/or a combination of audio and video content, can be distributed in a number of different ways. For example, analog audio and video content has been delivered for years using AM/FM radio broadcasts and UHF/VHF TV broadcasts. More recently, digital audio and video content has been delivered over private satellite broadcast networks, as well as by over-the-air transmission using terrestrial networks. In addition, digital audio/video content has been delivered over data communication networks, such as the internet, in the form of downloads of encoded audio files, such as MP3 files, as well as via “live” webcasts or streamcasts in which an audio stream is delivered and played in real time or near real time. Digital audio/video content may also be distributed over wireless communication networks, such as cellular and/or PCS networks. However, resource limitations of point-to-point communication networks can limit the availability of digital video programming over such networks.

A number of standards for digital video distribution have been proposed. In particular, the DVB (for Digital Video Broadcasting) standard promulgated by the European Telecommunications Standards Institute (ETSI) has developed a significant presence for digital television broadcasting. DVB is actually a suite of standards, that includes distribution standards via terrestrial wireless networks (DVB-T), digital video broadcasting via satellite (DVB-SH), and digital video broadcasting via cable (DVB-C)

The DVB suite also includes a standard for distributing video to mobile handheld devices, known as DVB-H. Distribution of video to mobile devices presents a number of technical challenges, primarily due to the need for a handheld device to have low power, weight and size, and for the device to be transportable at various speeds. For example, the power consumption limits on a mobile device make it impractical for the device to operate with its local oscillator and signal amplifier switched on at all times. Accordingly, the DVB-H standard provides for time-slicing, in which individual programs are broadcast in bursts, allowing the receivers to go into a sleep mode between bursts to conserve power.

In addition, DVB-H provides a forward error correction protocol that can help deal with some characteristic aspects of a mobile channel, such as rapidly varying channel conditions, multipath propagation, and the like. However, some problems that are common to mobile channels are so severe that even the DVB-H scheme can have difficulty dealing with them. For example, shadowing, in which the main component of a multipath signal is partially or completely blocked, can severely degrade the signal.

FIG. 1 is a schematic diagram illustrating multipath propagation and shadowing in a mobile communication environment. As shown therein, a wireless signal is transmitted by a wireless transmitter 10 to a mobile receiver 12. The primary ray 14 of the wireless signal is blocked by a building 22, so that there is no line of sight between the antenna of the transmitter 10 and the antenna of the receiver 12. However, another ray 16 of the wireless signal is reflected off of a building 24 to the receiver 12. Many other reflected rays may reach the receiver 12. However, each ray will reach the receiver over a different path with a different propagation time. Receivers are designed to coherently combine many different multipath rays to produce a useful received signal. However, it may still be difficult under some circumstances for a shadowed receiver to receive and correctly decode a digital video signal.

In addition to the shadowing and multi-path propagation problems, there can be coverage limitations for DVB transmission systems. For example, it is likely that metropolitan areas will be well covered by DVB-H terrestrial transmitters, because they can make use of the same facilities as DVB-T or digital video broadcast. However, suburban and/or rural areas may not have adequate coverage. Thus, it can be difficult to promote mobile digital video service in some geographic regions.

### SUMMARY

A system for broadcasting digital information according to some embodiments includes a digital video front end processor configured to process a digital video signal for broadcast by a digital video transmitter. The digital signal may include a plurality of sequential datagrams and the digital video front end processor may be configured to generate a digital transmission stream in response to the digital video signal and to modulate the digital transmission stream. The system further includes a first transmitter configured to receive the modulated digital transmission stream from the front end and to broadcast the modulated digital transmission stream over a first communication interface, and a second transmitter configured to receive the plurality of datagrams and to transmit selected ones of the plurality of datagrams to a receiving terminal over a second communication interface different from the first communication interface in response to a request from the receiving terminal.

The datagrams may be transmitted by the first transmitter at a first information rate and the re-transmitted datagrams may be transmitted by the second transmitter at a second information rate lower than the first information rate.

The first transmitter may include a digital video broadcasting (DVB) transmitter and the second transmitter may include a cellular radio transmitter.

The front end processor may be configured to encapsulate and apply error correction coding to the datagrams before generating the digital transmission stream. In some embodiments, the front end processor may be configured to provide the datagrams to the second transmitter without encapsulation or error correction coding. In other embodiments, the front end processor may be configured to encapsulate and apply error correction coding to the datagrams before transmitting the datagrams to the second transmitter.

The second transmitter may be configured to request a selected datagram from the front end processor when re-transmission of the selected datagram may be requested by the receiving terminal.

The system may further include a cellular DVB server configured to receive the datagrams from the front end processor and to provide the datagrams to the second transmitter in response to the request from the receiving terminal. The cellular DVB server may be configured to transmit datagrams to the receiving terminal until the receiving terminal indicates that it is able to receive the modulated digital transmission stream over the first communication interface.

A wireless terminal according to some embodiments includes a receiver configured to receive a modulated digital signal over a first wireless communication interface, to demodulate the digital signal, and to decapsulate a datagram encoded in the digital signal. The terminal further includes a transceiver configured to perform bidirectional data communication over a second wireless communication interface, and a control unit configured to receive the decapsulated datagram from the receiver. The control unit may be configured to determine if a datagram is missing from the digital signal and/or is corrupted, and in response to determining that a datagram is missing and/or corrupted, to request retransmission of the missing/corrupted datagram over the second wireless communication interface. The receiver may include a DVB receiver and the transceiver may include a cellular radio transceiver.

The transceiver may be configured to receive the retransmitted datagram over the second wireless communication interface and to provide the retransmitted datagram to the control unit.

The receiver may include a demodulator configured to demodulate the digital signal and a decapsulator configured to recover the datagram from the demodulated digital signal, and the transceiver may be configured to receive an encapsulated datagram over the second communication interface and to provide the encapsulated datagram to the decapsulator.

The wireless terminal may further include a presentation unit coupled to the control unit. The presentation unit may be configured to receive the datagrams from the control unit and to convert the datagrams into a displayable video signal.

Some embodiments provide a digital video server coupled to a cellular communication system and configured to receive a datagram of a digital video signal from a digital video front end processor over a first communication interface. The digital video server is configured to transmit the datagram to a wireless terminal over a second communication interface in the cellular communication system in response to a request for the datagram received from the wireless terminal over the second communication interface.

The digital video server may include a digital video receiver configured to receive a broadcast digital video signal including the datagram, and the digital video server may be configured to extract the datagram from the broadcast digital video signal.

The digital video server may be configured to decapsulate the datagram before transmitting the datagram to the wireless terminal.

The digital video server may be configured to remove forward error correction coding from the datagram before transmitting the datagram to the wireless terminal.

The digital video server may be configured to receive the datagram as an unencapsulated datagram from the digital video front end processor. The digital video server may be configured to transmit datagrams to the wireless terminal over the second communication interface until the wireless terminal indicates that it is able to receive the broadcast digital video signal.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic diagram illustrating multipath propagation and shadowing in a mobile communication environment.

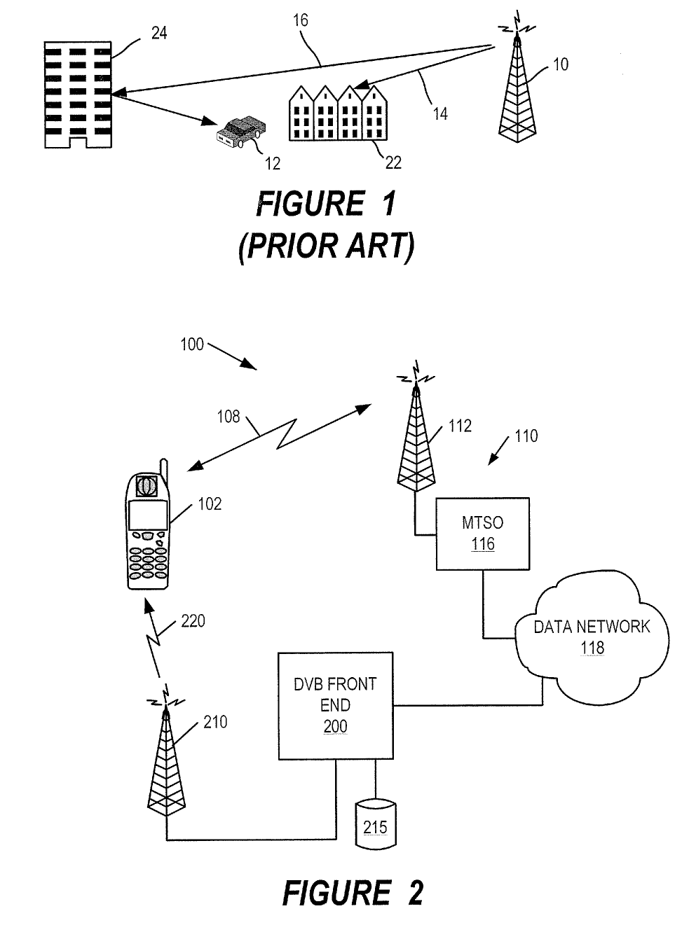

FIG. 2 is a schematic block diagram illustrating wireless communication terminals, a cellular communication system, and a DVB-H distribution system in accordance with some embodiments.

FIG. 3 is a schematic diagram of a wireless communication terminal according to some embodiments.

FIGS. 4A, 4B and 4C are schematic block diagrams illustrating wireless communication terminals, a cellular communication system, and a DVB-H distribution system in accordance with some embodiments.

FIG. 5 is a schematic diagram illustrating components of a wireless communication terminal according to some embodiments.

FIGS. 6-8 are flowcharts illustrating operations of various system elements according to some embodiments.

### DETAILED DESCRIPTION OF EMBODIMENTS

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout. As used herein the term “comprising” or “comprises” is open-ended, and includes one or more stated elements, steps and/or functions without precluding one or more unstated elements, steps and/or functions. As used herein the term “and/or” includes any and all combinations of one or more of the associated listed items.

Embodiments according to the present invention are described with reference to block diagrams and/or operational illustrations of methods and communication terminals. It is to be understood that each block of the block diagrams and/or operational illustrations, and combinations of blocks in the block diagrams and/or operational illustrations, can be implemented by radio frequency, analog and/or digital hardware, and/or program instructions. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

As used herein, a “communication terminal” (or simply a “terminal”) includes, but is not limited to, a device that is configured to receive/transmit communication signals via a wireline connection, such as via a public-switched telephone network (PSTN), digital subscriber line (DSL), digital cable, a direct cable connection, and/or another data connection/network, and/or via a wireless interface with, for example, a cellular network, a wireless local area network (WLAN), a digital television network such as a DVB-H network, a satellite network, an AM/FM broadcast transmitter, and/or another communication terminal. A communication terminal that is configured to communicate over a wireless interface may be referred to as a “wireless communication terminal,” a “wireless terminal” and/or a “mobile terminal.” Examples of wireless terminals include, but are not limited to, a satellite or cellular radiotelephone; a Personal Communications System (PCS), cellular, or similar terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver.

As noted above, wireless transmission of digital video can be problematic, due to such problems as multipath propagation and shadowing. Furthermore, while DVB infrastructure may be widely installed in metropolitan areas, there may be less DVB infrastructure serving rural and/or suburban areas. Some embodiments provide systems and/or methods for digital video distribution in which distribution of digital video by a digital video broadcast system such as DVB-H is complemented by a two-way point-to-point communication system, so that problems such as fading and shadowing can be seamlessly addressed as needed. Furthermore, in contrast to DVB systems, cellular spectrum tends to be more crowded (and therefore more valuable) in metropolitan areas, but is less crowded in suburban/rural areas. Therefore, systems/methods according to some embodiments are provided which can easily transition between broadcast-based distribution (which saves spectrum and/or point-to-point infrastructure costs in metropolitan areas) and point-to-point (e.g., two-way cellular) distribution, for example, to save broadcast infrastructure costs in suburban/rural areas.

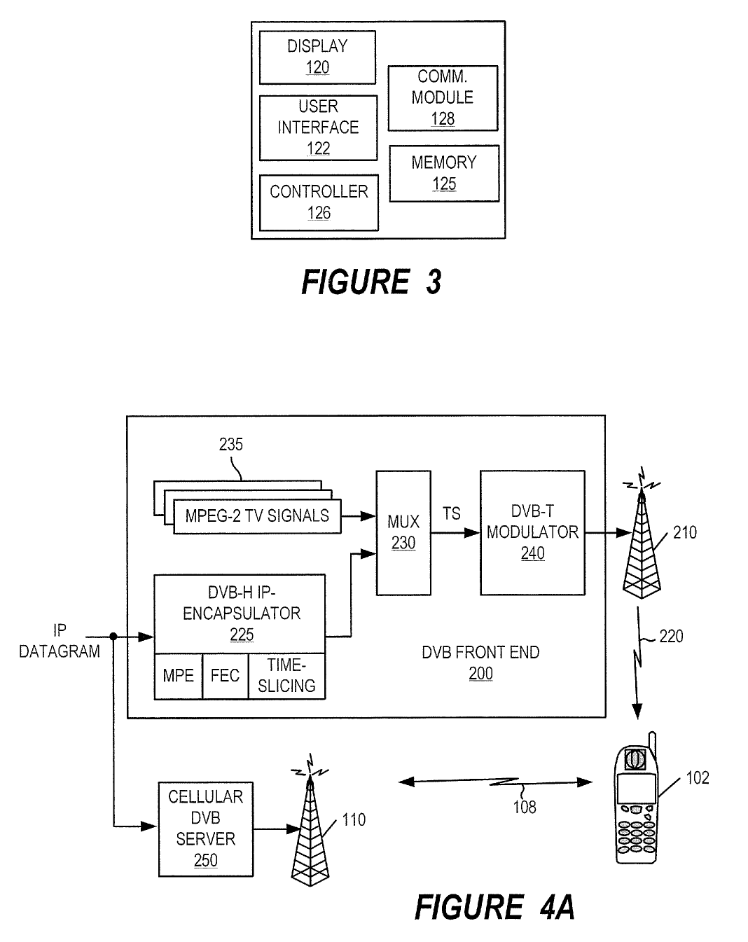

FIG. 2 is a schematic diagram of a wireless communication system 100 that includes a wireless terminal 102 that is configured to communicate with a cellular communication system 110 including one or more cellular base stations 112. The wireless terminal 102 is also configured to receive DVB-H signals 220 from a DVB transmitter 210. As explained below, the DVB transmitter 210 can simultaneously broadcast DVB-T signals as well as DVB-H signals. The wireless terminal 102 may be a handheld wireless communication terminal, such as a mobile telephone, PDA, laptop computer, or the like.

The DVB signals transmitted by the DVB transmitter 210 are generated by a DVB front end processor 200. For example, a digital video program stored in a digital storage facility 215 can be formatted by the DVB front end processor 200 and provided to the DVB transmitter 210 for broadcast transmission.

The DVB front end processor 200 can also receive programs for broadcast from remote locations, for example, through the data communication network 118.

The cellular base station 112 may be connected to a Mobile Telephone Switching Office (MTSO) 116, which, in turn, may be connected to a data communication network 118 (e.g. the Internet, and/or another network).

The MTSO 116 and the DVB front end processor 200 can communicate, for example, through the data communication network 118. In some DVB implementations, authentication control functions for DVB service can be provided to the DVB receiver in the wireless terminal 102 using the cellular system. Furthermore, according to some embodiments, some DVB program data can be provided to the wireless terminal 102 via the cellular communication system 110. For example, datagrams that are broadcast by the DVB transmitter 210 but that are not correctly received at the wireless terminal 102 can be re-transmitted on demand to the wireless terminal 102 through the cellular communication system 110, as discussed in more detail below.

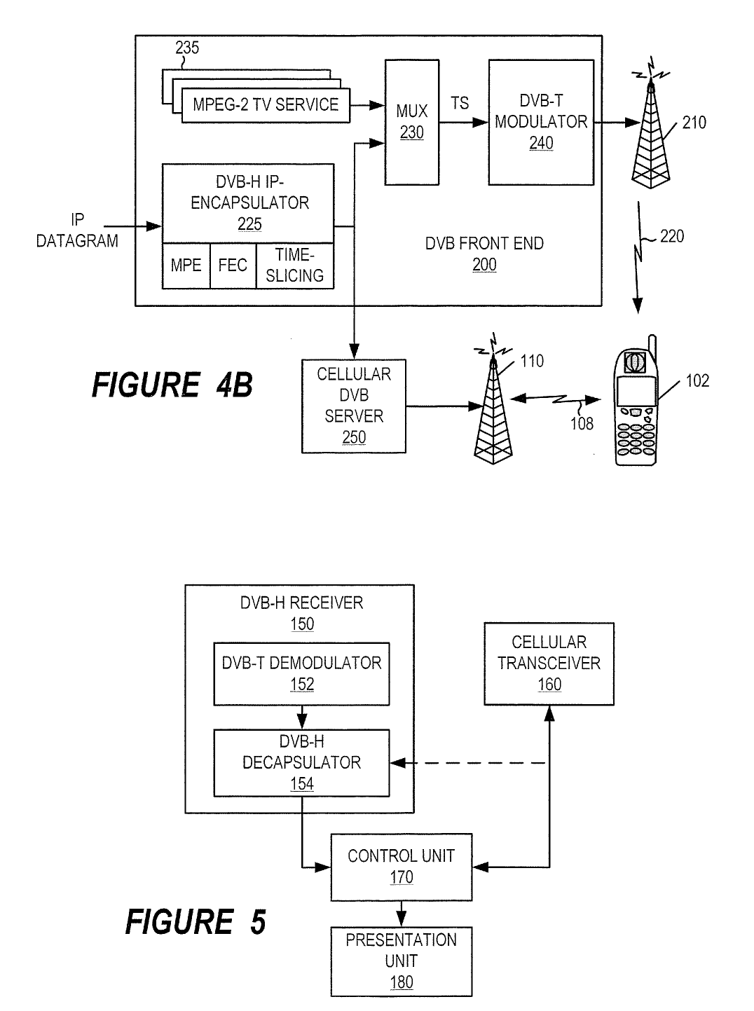

As illustrated in FIG. 3, the terminal 102 may include a display device 120, a user interface 122, a controller 126, a communication module (comm. module) 128, and a memory 125. The display device 120 may be capable of displaying video signals in a video format such as Quarter VGA (QVGA, 320×240 pixels), Common Intermediate Format (CIF, 360×288 pixels) and/or Quarter Common Intermediate Format (QCIF, 180×144 pixels). The terminal 102 may include appropriate CODECs to permit the terminal 102 to decode and display video signals in various formats.

The user interface 122 can include a keypad, keyboard, touchpad, jog dial and/or other user input device. The user interface 122 can also include a microphone coupled to an audio processor that is configured to generate an audio data stream responsive to sound incident on the microphone, a speaker that generates sound responsive to an input audio signal, and/or a camera that captures digital still and/or video images. The communication module 128 is configured to communicate data over one or more of the wireless interfaces. The memory 125 can include a nonvolatile memory that is capable of storing digital information even when power to the terminal 102 is switched off.

The communication module 128 can include, for example, a cellular communication module, a Bluetooth module, an infrared communication module, and/or a WLAN module. The communication module 128 can also include a DVB-H receiver that can receive DVB-H signals from a remote DVB transmitter 210. With a cellular communication module, the terminal 102 can communicate via the base station 112 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS).

As discussed above, multipath propagation and shadowing can present relatively severe problems for digital video distribution to mobile wireless terminals. For example, shadowing can cause a complete loss of usable signal power in some environments. This can be a particular problem in a DVB transmission system, because DVB-T/H transmitters are typically situated much less densely than, for example, cellular telephone antennas. Indeed, there may be just one DVB transmitter serving a relatively large municipal area.

In DVB-SH, the DVB standard for satellite digital video transmission, shadowing has proven to be such a problem that the broadcast signals are interleaved over a very long time period, such as 10 seconds. However, this approach requires the receiver to have a relatively large receive buffer able to store the received data for the length of the interleave period. Even with such a long interleave period, some data packets may be lost.

Furthermore, some techniques for addressing multipath propagation problems are not available in a portable handset. For example it is known that multipath propagation can be addressed using spatial diversity in the receiver antenna design. To utilize spatial diversity, a receiver can be provided with two or more antennas that are spaced far enough apart from one another that fading on the antennas is uncorrelated. However, in order to be commercially viable, a handheld wireless terminal must be so small that it is difficult to configure a multi-antenna system so that spatial diversity can be obtained. Multipath problems are especially acute in shadowed locations, since the direct path is blocked, leaving only reflected rays at the receiver.

According to some embodiments, a digital video distribution system, such as a DVB-H system operates in conjunction with a secondary wireless communication system, such as a cellular telephone system, to provide coordinated distribution of digital video signals. In general, a primary digital video signal is provided by the digital video distribution system. A wireless terminal that experiences a loss of the primary digital video signal, for example due to shadowing, can request retransmission of missed packets over the secondary wireless communication system. In this manner, seamless delivery of the digital video signal can be provided to a user of the wireless terminal even under conditions in which the primary digital video signal is at least temporarily lost.

Furthermore, according to some embodiments, transmission of the digital video signal to some mobile users can be handed over completely to the secondary wireless communication system. For example, as noted above, digital video broadcast infrastructure may not be available in some areas, such as in rural/suburban areas, while point-to-point communications infrastructure, such as cellular/PCS infrastructure may be available in those areas.

In many cases, a secondary wireless communication system, such as a cellular telephone system, is already available to a digital video receiver. For example, a DVB-H system may use the data communication capabilities of an existing cellular system for authentication, service control, and the like. It will be appreciated that such point-to-point communication systems are typically slower and operate with a narrower bandwidth and/or a lower data rate than DVB systems. However, such systems may provide established mechanisms for data communications, and are more likely to maintain contact with the wireless terminal even when the wireless terminal is temporarily shadowed relative to the DVB transmitter, and/or when a DVB transmitter is otherwise unavailable to the wireless terminal. Furthermore, wireless communication systems, such as cellular communication systems, already typically define protocols for transmitting IP datagrams to wireless terminals.

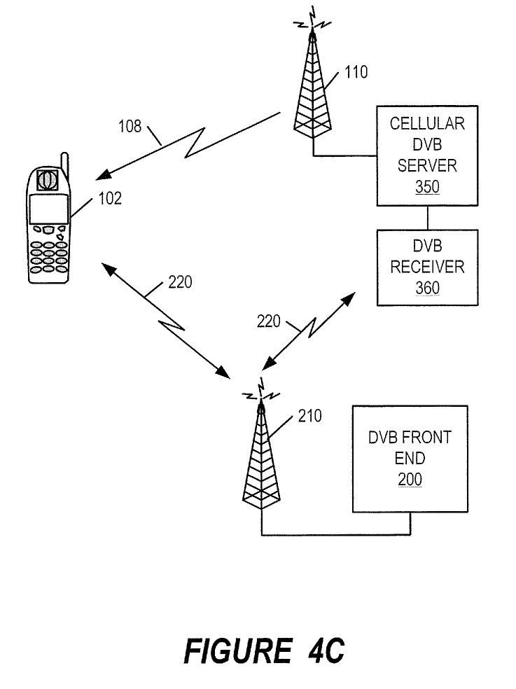

A DVB-H system according to some embodiments is illustrated schematically in FIG. 4A. The system 100 includes a DVB front end processor 200 connected to a DVB transmitter 210 and a cellular DVB server 250 that is connected to a cellular communication system 110. A wireless terminal 102 receives DVB signals 220 from the DVB transmitter 210 and communicates with the cellular communication system 110. The DVB front end processor 200 includes a DVB-H encapsulator 225, a multiplexer 230 and a DVB-T modulator 240.

As shown therein, a DVB front end processor 200 receives, as IP datagrams, a video signal for broadcast as a DVB-H signal. The DVB-H IP encapsulator 225 receives the IP datagrams and performs front-end processing of the IP datagrams to place them into an appropriate format for DVB-H transmission. For example, the DVB-H IP encapsulator 225 encapsulates the IP datagrams in a multi- protocol encapsulation (MPE). The DVB-H IP encapsulator 225 also adds forward error correction (FEC) to the IP datagrams, and time-slices the IP datagrams for transmission in bursts.

The encapsulated IP datagrams of the DVB-H signal may then be multiplexed with a plurality of MPEG-2 television signals 235 via the multiplexer 230. Multiplexed DVB-T and DVB-H signals can be transmitted simultaneously by the same DVB transmitter. The multiplexed signals form a transmission stream (TS) that is modulated by a DVB-T modulator 240 and transmitted by the DVB transmitter 210 for reception by the wireless terminal 102. The DVB modulator 240 modulates the transmission stream using orthogonal frequency domain modulation (OFDM).

As further shown in FIG. 4A, the IP datagrams that are processed by the DVB-H IP encapsulator 225 can also be provided to a cellular DVB server 250 that may be located within the cellular communication system 110 and/or that can otherwise communicate with the cellular communication system 110 that is serving the wireless terminal 102. The cellular DVB server 225 can be implemented, for example, within an MTSO 116, a base station 112, or can be implemented remotely. For example, referring to FIGS. 2 and 4A, the cellular DVB server 225 could communicate with the MTSO 116 through the data communication network 118.

In some embodiments, the IP datagrams received by the cellular DVB server 250 may not be transmitted immediately by the cellular communication system 110. Rather, the IP datagrams may be transmitted only upon request by the wireless terminal 102. For example, if the wireless terminal 102 experiences a severe fade of the DVB channel 220, the wireless terminal 102 can request retransmission of the missing datagrams from the cellular communication system 110. The cellular DVB server 250 can provide the requested datagrams to the cellular communication system 110, which transmits the datagrams to the wireless terminal 102.

In some embodiments, if the cellular DVB server 250 determines that the wireless terminal 102 is unable to receive the DVB broadcast signal 220, the cellular DVB server 250 may cause the wireless communication system 110 to transmit all of the IP datagrams to the wireless terminal 102. In that case, responsibility for transmission of the program to the wireless terminal 102 has effectively been handed over to the wireless communication system 110. When the wireless terminal 102 returns to an area served by a DVB transmitter 210, the cellular DVB server 250 may return to transmitting IP datagrams only upon request by the wireless terminal 102.

In some embodiments, the IP datagrams may not be transmitted to the cellular DVB server 250 until requested by the wireless terminal 102. That is, when a request for retransmission of an IP datagram is received by the cellular DVB server 250, the cellular DVB server 250 can in turn request the IP datagram from the DVB front end processor 200.

The requested datagrams can be transmitted from the cellular communication system 110 to the wireless terminal, for example, using a point-to-point cellular data communication protocol, such as the cellular digital packet data (CDPD) protocol and/or any other data communication protocol available in the cellular network 105.

As the data transmission rate of a cellular network is typically less than the data transmission rate of a DVB-H system, the wireless terminal 102 can buffer incoming datagrams from the DVB transmitter 210 until the requested datagram arrives from the cellular communication system 110. When the requested datagram arrives, it can be processed by the wireless terminal 102 in the correct order.

However, since DVB-H signals are sent only during selected time intervals, it may in some cases be possible to receive the requested datagram during a time period when the DVB-H receiver would otherwise be off, and in some cases to receive the requested datagram from the cellular communication system 105 before the next datagram is sent by the DVB-H transmitter 210. Therefore, there may not be a significant delay in waiting for the requested datagram to arrive and/or the reception of the retransmitted datagrams may not interfere with the reception of other datagrams from the DVB transmitter 210. The communication module 128 (FIG. 3) of the wireless terminal 102 may have to be awake and receiving during time periods when it would otherwise be switched off. However, the extra battery power used to keep the communication module on during those times may be justified by the ability of the wireless terminal 102 to continuously display the video signal without interruptions.

In some embodiments, the functions of the cellular DVB server 250 can be implemented in the DVB front end processor 200. That is, when the wireless terminal 102 requires re-transmission of an IP datagram, the wireless terminal 102 can transmit a request for retransmission to the DVB front end 200 through the cellular communication system 110, which can re-transmit the IP datagram as packet data to the wireless terminal 102 through the cellular communication system 110.

It will be appreciated that in the embodiments illustrated in FIG. 4A, the IP datagrams are provided to the cellular DVB server 250 before encapsulation by the DVB-H IP encapsulator 225. Accordingly, the IP datagrams may not be provided with forward error correction. However, it may be acceptable for the IP datagrams provided by the cellular communication system 110 not to have forward error correction, as adding FEC to the datagrams increases the number of bits that must be transmitted for a given packet of data. Furthermore, it may be acceptable for the IP datagrams sent by the cellular communication system 110 to be sent without forward error correction even if the resulting datagrams may be received with errors, since the errors may only affect a few frames of the video signal. Moreover, many cellular communication systems will add their own redundancy/error correction bits to the transmission anyway. It may still be desirable for the cellular DVB server 250 to add FEC bits to the IP datagrams, depending on the particular protocol used by the cellular communication system 110. For example, WCDMA 3GPP permits a transparent mode in which the radio protocol only maintains contact with the mobile and does not guarantee receipt.

FIG. 4B illustrates systems and/or methods according to further embodiments. Many of the elements illustrated in FIG. 4B are similar to the corresponding elements illustrated in FIG. 4A, and will not be described again. As illustrated in FIG. 4B, in some embodiments, the IP datagrams may be provided to the cellular DVB server 250 after encapsulation by the DVB-H IP encapsulator 225. Accordingly, the datagrams transmitted by the cellular communication system 110 may have forward error correction. In that case, the wireless terminal 102 would process the incoming datagrams from the cellular communication system 110 in the same manner as datagrams received from the DVB transmitter 210.

Furthermore, as illustrated in FIG. 4C, in some embodiments, a cellular DVB server 350 can include and/or be coupled to a DVB receiver 360. The DVB receiver 360 can extract the IP datagrams from the DVB signal 220, and the cellular DVB server 350 can retransmit selected ones of the IP datagrams over the cellular interface 108 in response to a request from the wireless terminal 102. The IP datagrams can be decapsulated, or not decapsulated, by the cellular DVB server 350 before being transmitted to the wireless terminal 102 over the cellular interface 108. The DVB receiver 350 can be a fixed receiver utilizing spatial diversity, polarization diversity and/or other techniques to combat multipath fading and shadowing. Moreover, the antenna(s) of the DVB receiver 360 can be positioned to reduce the possibility of shadowing, so that the chance of losing the DVB signal at the DVB receiver 360 is reduced.

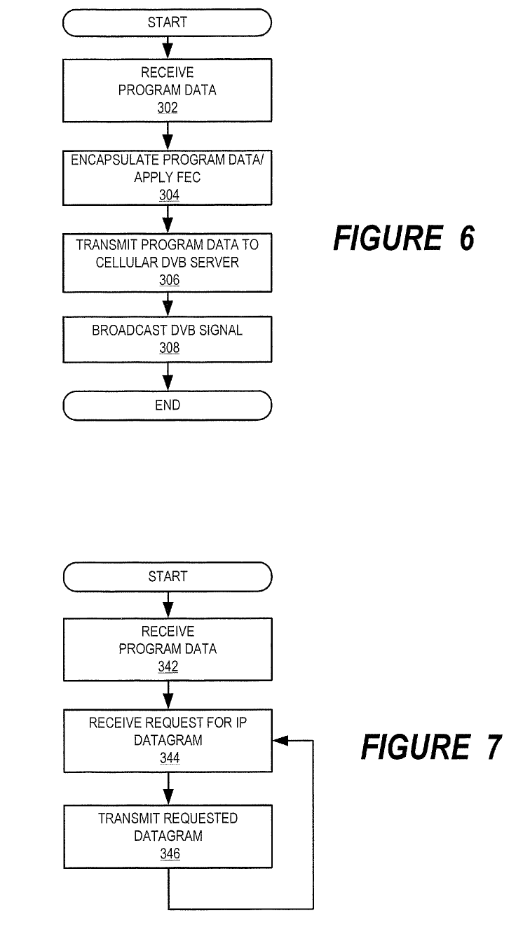

A receiver of a wireless terminal 102 according to some embodiments is illustrated in FIG. 5. As shown therein, the receiver can include a DVB receiver 150, a cellular transceiver 160, a control unit 170, and a presentation unit 180. The DVB-H receiver 150 includes a DVB-T demodulator 152 and a DVB-H decapsulator 154. The DVB-T demodulator 152 demodulates the received OFDM DVB signal and passes the demodulated signal to the DVB-H decapsulator 154. The DVB-H decapsulator 154 extracts the IP datagram using FEC information embedded in the signal, and provides the IP datagram to the control unit 170. The control unit 170 checks to see if the IP datagram was correctly received. If the control unit 170 determines that a datagram is missing or if a received datagram is corrupted with errors and is unusable, the control unit transmits a message to the DVB server 250 (FIG. 4A) via the cellular transceiver 160 identifying the missing IP datagram and requesting retransmission of the datagram.

The retransmitted datagram is received by the cellular transceiver and provided to the control unit 170, in the case of an unencapsulated datagram. If the datagram is encapsulated with FEC, the datagram can be provided by the cellular transceiver 160 and/or by the control unit 170 to the DVB-H decapsulator 154, which can decapsulate the IP datagram and provide the IP datagram to the control unit 170. The received IP datagrams are provided to the presentation unit 180, which can include a video codec configured to convert the IP datagrams into a displayable video signal.

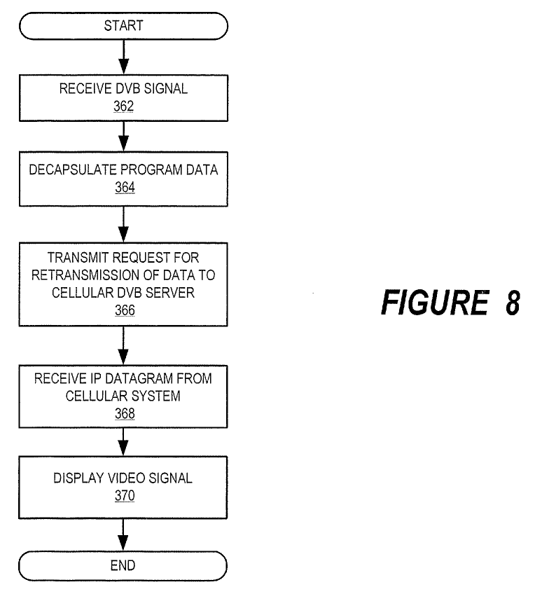

Methods for providing digital video content according to some embodiments are illustrated in FIGS. 6 and 7. Referring to FIG. 6, some operations of a DVB front end are illustrated. Program data for a video program that is to be broadcast over a digital video broadcast system is received (Block 302), e.g., in a DVB front end processor 200. The program data is received as a series of IP datagrams. The program data is encapsulated, and forward error correction is applied to the data (Block 304). The program data, in encapsulated or unencapsulated form, is transmitted to a cellular DVB server that can transmit the program data over a secondary wireless communication system, such as a cellular communication system (Block 306). The encapsulated program data is broadcast as a DVB signal by a DVB transmitter (Block 308). For example, the encapsulated program data can be time sliced and multiplexed together with other data in a transmission stream, and the transmission stream can be modulated and transmitted.

Operations of a cellular DVB server according to some embodiments are illustrated in FIG. 7. As shown therein, program data is received from the DVB front end (Block 342). The cellular DVB server then waits for a request from a DVB receiver via a cellular communication system for retransmission of an IP datagram (Block 344). Upon receipt of such a request, the cellular DVB server causes the requested datagram to be transmitted to the DVB receiver via the cellular communication system (Block 346). Operation of the cellular DVB server then returns to Block 344 and waits for a subsequent request for retransmission of an IP datagram, at which time operations of Blocks 344 and 346 repeat. In some embodiments, the cellular DVB server may automatically transmit all IP datagrams to the DVB receiver over the cellular communication system until the DVB receiver can again receive the DVB broadcast signal.

Operations of a wireless terminal according to some embodiments are illustrated in FIG. 8. As shown therein, a DVB signal is received by a DVB receiver of a wireless terminal (Block 362). The DVB receiver demodulates the DVB signal and decapsulates the program data in the signal (Block 364). The wireless terminal then checks to see if the IP datagram was received correctly or if an IP datagram was missed. If so, the wireless terminal transmits a request via a cellular communication network to a cellular DVB server for retransmission of the missing/corrupted IP datagram (Block 366). The wireless terminal then receives the retransmitted IP datagram (Block 368) and generates and displays a video signal using the received IP datagram (Block 370).

While some embodiments have been described in the context of a DVB-H video distribution system, it will be appreciated that the present invention is not limited to the use of digital video distribution systems that comply with one or more of the DVB standards. Rather, embodiments of the invention can be applied to many different kinds of video distribution systems, including standard systems and proprietary systems. Moreover, while some embodiments are described in which a cellular communication system is used as the secondary communication system for providing retransmission of digital video data, it will be appreciated that other types of wireless data communication systems could be used to provide retransmission of missing/corrupted video data. Moreover, where a cellular communication system is used as the secondary communication system, many different kinds of cellular systems could be used. For example, the cellular communication system could include implement any standard that provides digital data communication, such as AMPS, IS-54, IS-95, GSM, cdma2000, UMTS, and others.

The present invention has been described in part with reference to flowchart illustrations illustrating exemplary operations for playing a downloaded multimedia program according to aspects of the present invention. It will be understood that blocks of the flowchart illustrations, and combinations of blocks in the flowchart illustrations, may be implemented using electronic circuits included in communication terminals, such as the wireless terminal 102. It will also be appreciated that blocks of the flowchart illustrations, and combinations of blocks in the flowchart illustrations, may be implemented using components other than those illustrated in FIGS. 2 to 5, and that, in general, the blocks of the flowchart illustrations and combinations of blocks in the flowchart illustrations, may be implemented in special purpose hardware such as discrete analog and/or digital circuitry, such as combinations of integrated circuits or one or more application specific integrated circuits (ASICs), as well as by computer program instructions which may be loaded onto a computer or other programmable data processing apparatus to produce a machine such that the instructions which execute on the computer or other programmable data processing apparatus create means for implementing the functions specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations support electronic circuits and other means for performing the specified functions/acts, as well as combinations of steps for performing the specified functions/acts. It will be understood that the circuits and other means supported by each block of the flowchart illustrations, and combinations of blocks therein, can be implemented by special purpose hardware, software or firmware operating on special or general purpose data processors, or combinations thereof.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A system for broadcasting digital information, comprising:
a digital video front end processor configured to process a digital video signal for broadcast by a digital video transmitter, wherein the digital signal comprises a plurality of sequential datagrams and wherein the digital video front end processor is configured to generate a digital transmission stream in response to the digital video signal and to modulate the digital transmission stream;
a first transmitter configured to receive the modulated digital transmission stream from the front end and to broadcast the modulated digital transmission stream over a first communication interface; and
a second transmitter configured to receive the plurality of datagrams and to transmit selected ones of the plurality of datagrams to a receiving terminal over a second communication interface different from the first communication interface in response to a request from the receiving terminal.

2. The system of claim 1, wherein the datagrams are transmitted by the first transmitter at a first information rate and wherein the re-transmitted datagrams are transmitted by the second transmitter at a second information rate lower than the first information rate.

3. The system of claim 1, wherein the first transmitter comprises a digital video broadcasting (DVB) transmitter and the second transmitter comprises a cellular radio transmitter.

4. The system of claim 1, wherein the front end processor is configured to encapsulate and apply error correction coding to the datagrams before generating the digital transmission stream.

5. The system of claim 4, wherein the front end processor is configured to provide the datagrams to the second transmitter without encapsulation or error correction coding.

6. The system of claim 4, wherein the front end processor is configured to encapsulate and apply error correction coding to the datagrams before transmitting the datagrams to the second transmitter.

7. The system of claim 1, wherein the second transmitter is configured to request a selected datagram from the front end processor when re-transmission of the selected datagram is requested by the receiving terminal.

8. The system of claim 1, further comprising a cellular DVB server configured to receive the datagrams from the front end processor and to provide the datagrams to the second transmitter in response to the request from the receiving terminal.

9. The system of claim 1, wherein the cellular DVB server is configured to transmit datagrams to the receiving terminal until the receiving terminal indicates that it is able to receive the modulated digital transmission stream over the first communication interface.

10. A wireless terminal, comprising:
a receiver configured to receive a modulated digital signal over a first wireless communication interface, to demodulate the digital signal, and to decapsulate a datagram encoded in the digital signal;
a transceiver configured to perform bidirectional data communication over a second wireless communication interface; and
a control unit configured to receive the decapsulated datagram from the receiver, wherein the control unit is configured to determine if a datagram is missing from the digital signal and/or is corrupted, and in response to determining that a datagram is missing and/or corrupted, to request retransmission of the missing/corrupted datagram over the second wireless communication interface.

11. The wireless terminal of claim 10, wherein the receiver comprises a DVB receiver and wherein the transceiver comprises a cellular radio transceiver.

12. The wireless terminal of claim 10, wherein the transceiver is configured to receive the retransmitted datagram over the second wireless communication interface and to provide the retransmitted datagram to the control unit.

13. The wireless terminal of claim 10, wherein the receiver comprises a demodulator configured to demodulate the digital signal and a decapsulator configured to recover the datagram from the demodulated digital signal, and wherein the transceiver is configured to receive an encapsulated datagram over the second communication interface and to provide the encapsulated datagram to the decapsulator.

14. The wireless terminal of claim 10, further comprising a presentation unit coupled to the control unit, wherein the presentation unit is configured to receive the datagrams from the control unit and to convert the datagrams into a displayable video signal.

15. A digital video server coupled to a cellular communication system and configured to receive a datagram of a digital video signal from a digital video front end processor over a first communication interface, and configured to transmit the datagram to a wireless terminal over a second communication interface in the cellular communication system in response to a request for the datagram received from the wireless terminal over the second communication interface.

16. The digital video server of claim 15, wherein the digital video server comprises a digital video receiver configured to receive a broadcast digital video signal including the datagram, and wherein the digital video server is configured to extract the datagram from the broadcast digital video signal.

17. The digital video server of claim 15, wherein the digital video server is configured to decapsulate the datagram before transmitting the datagram to the wireless terminal.

18. The digital video server of claim 15, wherein the digital video server is configured to remove forward error correction coding from the datagram before transmitting the datagram to the wireless terminal.

19. The digital video server of claim 15, wherein the digital video server is configured to receive the datagram as an unencapsulated datagram from the digital video front end processor.

20. The digital video server of claim 15, wherein the digital video server is configured to transmit datagrams to the wireless terminal over the second communication interface until the wireless terminal indicates that it is able to receive the broadcast digital video signal.
